(19) United States
(12) Patent Application Publication
(10) Pub. No.: US 2012/0231415 A1
(43) Pub. Date: Sep. 13, 2012

(54) Dental Handpiece with Air-Foil Bearings

(76) Inventor: Kevin Rogers Brennan, Arlington Heights, IL (US)

(21) Appl. No.: 13/364,512

(22) Filed: Feb. 2, 2012

Related U.S. Application Data
(63) Continuation of application No. 12/725,836, filed on Mar. 17, 2010, now abandoned.
Application No. 12/725,836 is a continuation of application No. 12/006,493, filed on Jan. 3, 2008, now abandoned.
Application No. 12/006,493 is a continuation of application No. 11/272,120, filed on Nov. 10, 2005, now abandoned.

(51) Int. Cl. A61C 1/05; B23P 17/00; A61C 1/08

(52) U.S. Cl. 433/104; 433/132; 29/888

(57) ABSTRACT

A dental handpiece of the type having a bearing supporting a turbine. At least one of the bearings is an air-foil type.

### RELATED APPLICATIONS

This application is a Continuation application of U.S. patent application Ser. No. 12/725,836 filed Mar. 17, 2010 which is a Continuation of U.S. patent application Ser. No. 12/006,493 filed Jan. 3, 2008 which is a Continuation of U.S. patent application Ser. No. 11/272,120 filed Nov. 10, 2005 and claims the benefit of U.S. Provisional Application Ser. No. 60/627,200 filed on Nov. 12, 2004.

### TECHNICAL FIELD

The present invention is directed toward dental handpieces and has particular application to high-speed, air-driven turbine handpieces. The invention is specifically directed to such handpieces using air-foil bearings.

### BACKGROUND OF THE INVENTION

Air bearings are known in for example, the environmental control systems industry for use with high-speed air cycle machines. A machine with foil air bearings is more reliable than one with rolling element bearings because it requires fewer parts to support the rotative assembly and needs no lubrication. In operation, the air/gas film between the bearing and the shaft protects the bearing foils from wear. The bearing surface is in contact with the shaft only when the machine starts and stops, and a coating on the foils limits wear at those times.

The principle of an air bearing, whether of the journal or thrust type, is simple. When two surfaces form a wedge and one surface moves relative to the other, pressure is generated between the surfaces due to the hydrodynamic action of the fluid carrying the load. In a journal bearing the shaft deflects and a wedge is formed due to the eccentricity between the shaft center and the bearing center.

Even though the principle of an air bearing is simple, application is complex. For instance, in a journal bearing the running radial clearance between the shaft and bearing is usually less than 0.0005 inch for a 2-inch-diameter shaft at 36,000 rpm. But the shaft growth caused by temperature and centrifugal force could be 0.0020 inch. In addition, damping is required to suppress any whirl instability, and there can be misalignment between various rotating parts and stationary parts.

These problems are solved by foil bearings. While the shaft is stationary, there is a small amount of preload between the shaft and the bearing. As the shaft turns, hydrodynamic pressure is generated, pushing the foils away from the shaft and making the shaft completely airborne. This phenomenon occurs instantly during start-up at a very low speed. When the shaft is airborne, the friction loss due to shaft rotation is quite small. As the shaft grows, the foils get pushed farther away, keeping the film clearance relatively constant. In addition, the foils provide coulomb damping due to their relative sliding. This damping is essential for the stability of the machine.

Dental handpieces, especially high-speed handpieces, often employ air-driven turbines to rotate a shaft and an attached dental tool (such tool often being a bur). The turbine is supported by a bearing. For example, U.S. Pat. No. 5,571,013 discloses such a bearing supported handpiece. That patent is hereby incorporated by reference for such disclosure.

It is often the case that dental handpiece bearings must be lubricated, which is a problem when such handpieces must be sterilized between each use. A dental handpiece that does not require lubrication would be of great benefit to the dental practitioner.

There is a desire to increase efficiency and robustness of dental handpiece turbine assemblies, two limiting factors are the roller bearings, which must operate at speeds ranging to 500 k rpm, and the lubricant required by the bearing rolling elements which must maintain lubricity despite sterilization. Air Foil bearings do not require lubrication, and are not speed limited.

### SUMMARY OF THE INVENTION

Therefore, according to the invention there is provided a dental handpiece of the type having a bearing supporting a turbine. At least one of the bearings is an air-foil type.

### BRIEF DESCRIPTION OF THE DRAWINGS

FIG. 1 shows a partially schematic view of a turbine head of a dental handpiece.

FIG. 2 shows a top plan view of an air-foil bearing.

FIG. 3 shows a foil bearing start-run-stop cycle.

### PREFERRED EMBODIMENT FOR CARRYING OUT THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

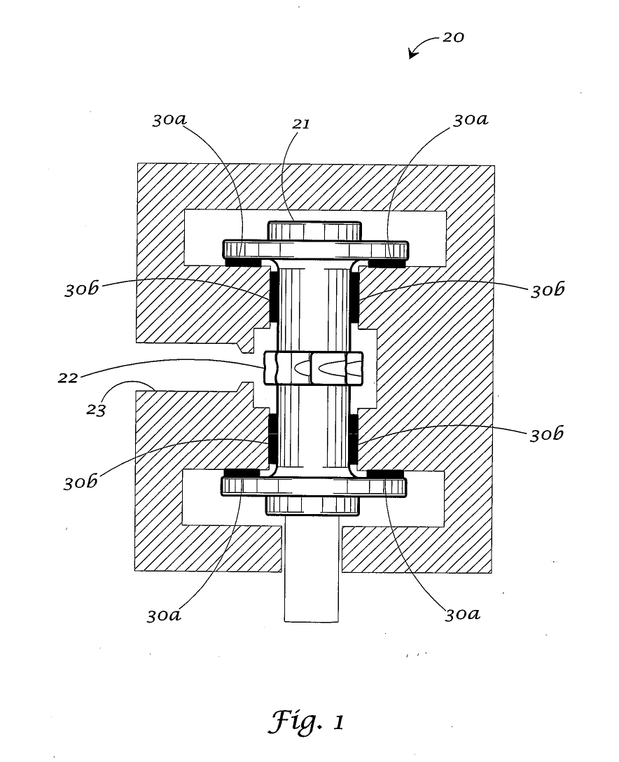

Referring to the drawing FIG. 1, a head 20 is shown. Head 20 is the type connected to a dental handpiece (not shown) as in for example, U.S. Pat. No. 5,040,980 entitled Dental Handpiece with Spring Grip Chuck and Lever Release Mechanism. The disclosure of U.S. Pat. No. 5,040,980 is herein incorporated by reference.

Head 20 includes a turbine 21 having blades 22. As is conventional, compressed air is caused to enter head 20 such as through passage 23 causing turbine 21 to rotate. Operatively affixed to turbine 21 is a dental tool such as bur 24.

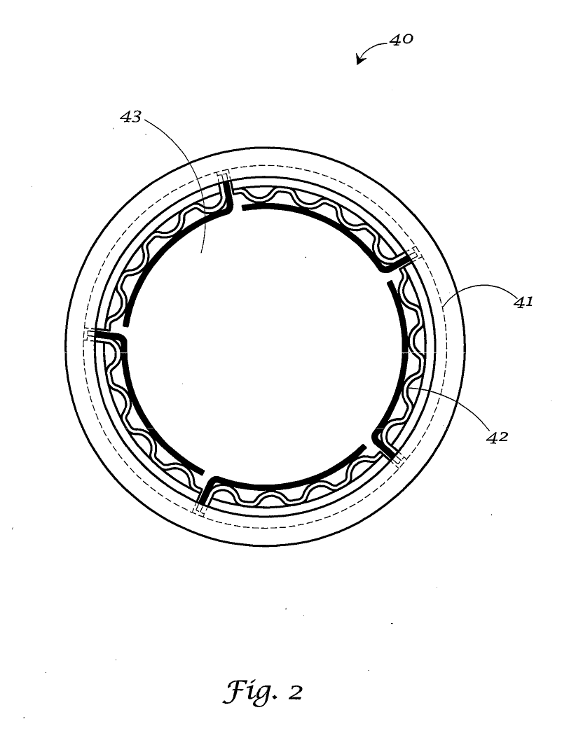

Supporting turbine 21 is at least one an preferably a plurality of air-foil bearings 30a and 30b. Preferably, bearings 30a are thrust air-foil bearings and bearings 30b are journal foil bearings. Air-Foil Bearings are self generating, compliant hydrodynamic bearings. The compliant foils are made to conform to the shape of the mating rotating shaft. During operation the shaft is supported on a thin film of self-generated cushion of air resulting in high load carrying capability and stability characteristics. An exemplary air-foil bearing 40 is shown in FIG. 2. It contains a thin layer of top foils 41 supported on corrugated foils 42. There is a small amount of preload between the shaft 43 and the bearing 40. For low friction during lift-off and touch-down, the foils are coated with a solid film lubricant. During lift-off, air is drawn between the shaft 43 and the bearing 40 and locally compressed. Due to hydrodynamic action, the shaft 43 lifts off and floats on a cushion of air. The self generated pressure on top foils 41 provides support for the shaft while the corrugated foils 42 provide the compliant feature of the bearing 40. The spring rate of the corrugated segments accommodate shaft expansion, shaft excursion and housing misalignment. The corrugated foils also provide a flow path for small amount of cooling air. The corrugated bump foils 42 also support the upper smooth foils 41 while providing whirl suppression.

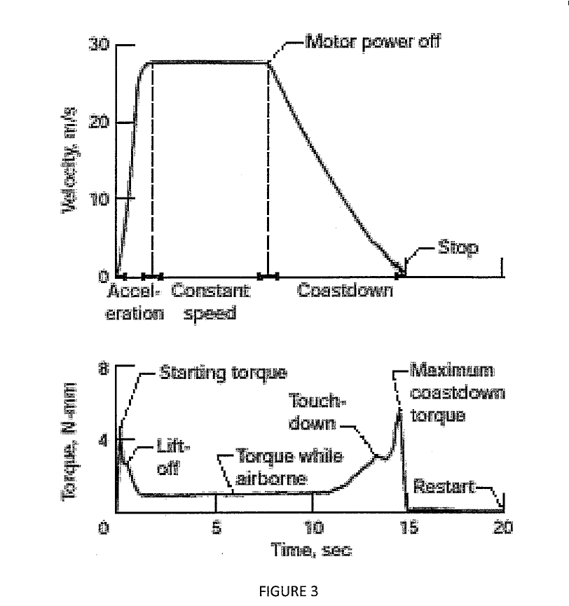

An example of a Foil bearing Start-Run-Stop cycle is shown in FIG. 3.

Air-foil bearings can be applied to a dental handpiece in any orientation or combination that sufficiently constrains the rotative assembly. The assembly can be placed in any location within the handpiece (i.e. the head or sheath). The air-cushion providing foil can be of numerous constructions or patterns that create a sufficient cushion to support the assembly within the handpiece's operating speed range.

The use of foil bearings in dental handpieces has numerous advantages:
Higher Reliability-Foil bearings are more reliable because there are fewer parts necessary to support the rotative assembly and there is no lubrication needed to feed the system. When the machine is in operation, the air/gas film between the bearing and the shaft protects the bearing foils from wear. The bearing surface is in contact with the shaft only when the machine starts and stops. During this time, a coating on the foils limits the wear.
No Scheduled Maintenance-There is no oil lubrication in foil bearings, there is never a need to replace lubricant. This results in lower operating costs.
Soft Failure-Because of the low clearances and tolerances inherent in foil bearing design and assembly, if a bearing failure does occur, the bearing foils restrain the shaft assembly from excessive movement. As a result, the damage is most often confined to the bearings and shaft surfaces.
Environmental Durability-Foil bearings can handle severe environmental conditions such as sand and dust ingestion. Larger particles do not enter into the bearing flow path because of a reversed pitot design at the cooling flow inlet and smaller particles are continually flushed out of the bearings by the cooling flow.
High Speed Operation-Air-Foil bearings are not subject to “mileage wearing” typical of conventional bearings in high-speed applications. In fact, due to the hydrodynamic action, they have a higher load capacity as the speed increases.
Sterilization-Oil lubricity is severely diminished by water absorption, Foil bearings do not require oil lubrication.
Low and High Temperature Capabilities-Many oil lubricants cannot operate at very high temperatures without breaking down. Foil bearings, however, operate efficiently at severely high temperatures.
Quieter Operation-Noise generating impact events of roller elements and excitation of the roller assembly is eliminated.
High vibration and shock load capacity-Sudden system speed changes do not create internal secondary impacts as with conventional roller bearings
Suspension-System suspension is simplified and provided by the foil spring rate.

It will be appreciated that an improved dental handpiece is accomplished by the invention as described herein. The scope of the invention shall be determined by the attached claims.

What is claimed is:

1. A dental handpiece of the type having an air-driven turbine having blades and mounted in the handpiece, and a passage for directing compressed air across the blades to cause the turbine to rotate, the turbine being mounted in the handpiece by at least one bearing and the turbine being operatively affixed to a dental tool; the improvement comprising the at least one bearing being an air-foil bearing.

2. The dental handpiece of claim 1, wherein said air-foil bearing comprises a top foil supported by a corrugated foil.

3. The dental handpiece wherein said corrugated foil has corregations that form a cooling air flow path.

4. The dental handpiece of claim 1, wherein said air-foil bearing is coated with a lubricant.

5. The dental handpiece of claim 4, wherein said lubricant is a solid film.

6. The dental handpiece of claim 1, wherein said air-foil bearing is a thrust bearing.

7. The handpiece of claim 1 wherein said air-foil bearing is a journal bearing.

8. A method of mounting an air-driven turbine in a dental handpiece, wherein the turbine has blades mounted on a shaft, and a passage is provided in the handpiece to cause compressed air to be directed across the blades to cause the turbine to rotate, comprising the step of:
mounting the turbine in the dental handpiece with at least one air-foil bearing.

9. A method as in claim 8, wherein said air-foil bearing is mounted such that there is an amount of preload between the shaft and said air-foil bearing.

10. A method as in claim 9, wherein air is drawn between the shaft and said air-foil bearing and is locally compressed, such that the local compression causes pressure on the air-foil bearing to thereby lift and support the shaft on a cushion of air.

11. A method of providing cooling air to a dental handpiece comprising the steps of:
providing an air-foil bearing having at least one corrugated layer having corrugations; mounting a turbine having blades in said air-foil bearing;
directing a flow of compressed air across said blades and between said shaft and said air-foil bearing; such that cooling air is caused to flow through said corrugations to provide a cooling effect to the handpiece.
